(19) United States
(12) Patent Application Publication
(10) Pub. No.: US 2024/0311506 A1
(43) Pub. Date: Sep. 19, 2024

(54) COMPUTERIZED SYSTEMS AND METHODS FOR SAFEGUARDING PRIVACY

(71) Applicant: YAHOO ASSETS LLC, New York, NY (US)

(72) Inventors: Jon MALKIN, Millbrae, CA (US); Srinivas BHAGAVATULA, Ashburn, VA (US); Chris WING, San Jose, CA (US); Daryl Low, San Jose, CA (US); George Fletcher, Round Hill, VA (US)

(21) Appl. No.: 18/183,224

(22) Filed: Mar. 14, 2023

(51) Int. Cl. G06F 21/62

(52) U.S. Cl. CPC G06F 21/6245

(57) ABSTRACT

The disclosed systems and methods provide a novel framework for management of data provenance and/or safeguarding personal data involved in electronic transactions. The framework enables the tracking of metadata that can be collected at event time and/or joined with a database to capture User Consent Data, Geopolitical Location Data, and Publisher Data, inter alia, in a structured, extensible way. The framework can function to merge metadata, which can enable functionality for a compact representation despite data being collected from various disparate records. Aggregation can be performed on data from an individual record identifier for more efficient pre-filtering and/or can be applied directly across large data sets. The framework can provide Access Control Logic functions to respond to and answer queries related to the aggregated data, in particular, whether the data set may be used for a data processing purpose specified at query time.

This application includes material that is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The present disclosure relates generally to managing data provenance, and more particularly to, safeguarding the privacy of user data across processing and consumption platforms, inclusive of networking and device platforms.

### BACKGROUND

Safeguarding the privacy of personal data has become an increasingly important part of data handling and processing in lieu of a variety of new rules and regulations from various countries and similar constraints being imposed by contractual obligations (e.g., contracts with other companies). Existing systems are poorly suited to handle the complex interactions between parties (or entities, for example) in the face of such constraints.

### SUMMARY

Currently, existing systems for tracking the provenance of data tend to focus heavily on data lineage for auditability, and on reproducible processing of data at a batch level. These are certainly important aspects of managing data usage. However, in enforcing the proliferation of data governance policies relating to data privacy, it has become essential to track the provenance of data at the record and/or sub-record level, and to preserve that provenance information through combinations and aggregations.

According to some embodiments, the disclosed systems and methods address the deficiencies in the common provenance models, as well as provide additional features, by efficiently collecting and aggregating information to handle complex queries that exceed the capabilities of simple lineage tracking. The disclosed framework can provide computerized functionality for aggregating records, which can enable the enforcement of governance policies for compliant processing while creating aggregate and/or derived records that are themselves subject to future processing policy restrictions.

Therefore, according to some embodiments, the disclosed systems and methods, as discussed herein, provide a novel framework that enables the tracking of metadata that can be collected at event time and/or joined with a database to capture User Consent Data, Geopolitical Location Data, and Publisher Data, inter alia, in a structured, extensible way. The disclosed framework can function to provide rules for merging metadata, which can enable functionality for a compact representation despite data being collected from various disparate records/sources (e.g., potentially billions of individual records, for example). In some embodiments, as discussed herein, aggregation can be performed on data from an individual record identifier for more efficient pre-filtering and/or can be applied directly across large data sets. As provided herein, the disclosed framework can additionally provide Access Control Logic (ACL) functions to respond to and answer queries related to the aggregated data, in particular, for example, whether the data set may be used for a data processing purpose specified at query time.

In accordance with one or more embodiments, the present disclosure provides computerized methods for a framework that safeguards personal data involved in cross-platform electronic transactions. In accordance with one or more embodiments, the present disclosure provides a non-transitory computer-readable storage medium for carrying out the above mentioned technical steps of the framework's functionality. The non-transitory computer-readable storage medium has tangibly stored thereon, or tangibly encoded thereon, computer readable instructions that when executed by a device cause at least one processor to perform a method for a novel and improved framework that safeguards personal data involved in electronic transactions.

In accordance with one or more embodiments, a system is provided that comprises one or more computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a schematic diagram illustrating an example of a network within which the systems and methods disclosed herein could be implemented according to some embodiments of the present disclosure;

FIG. 2 depicts a schematic diagram illustrating an example of client device in accordance with some embodiments of the present disclosure;

FIG. 3 is a block diagram illustrating components of an exemplary system in accordance with some embodiments of the present disclosure;

FIG. 4 is a block diagram illustrating an exemplary workflow in accordance with some embodiments of the present disclosure; and

FIG. 5 is a block diagram illustrating an exemplary workflow in accordance with some embodiments of the present disclosure.

### DESCRIPTION OF EMBODIMENTS

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router (WR) mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or consumer or user) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device an Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

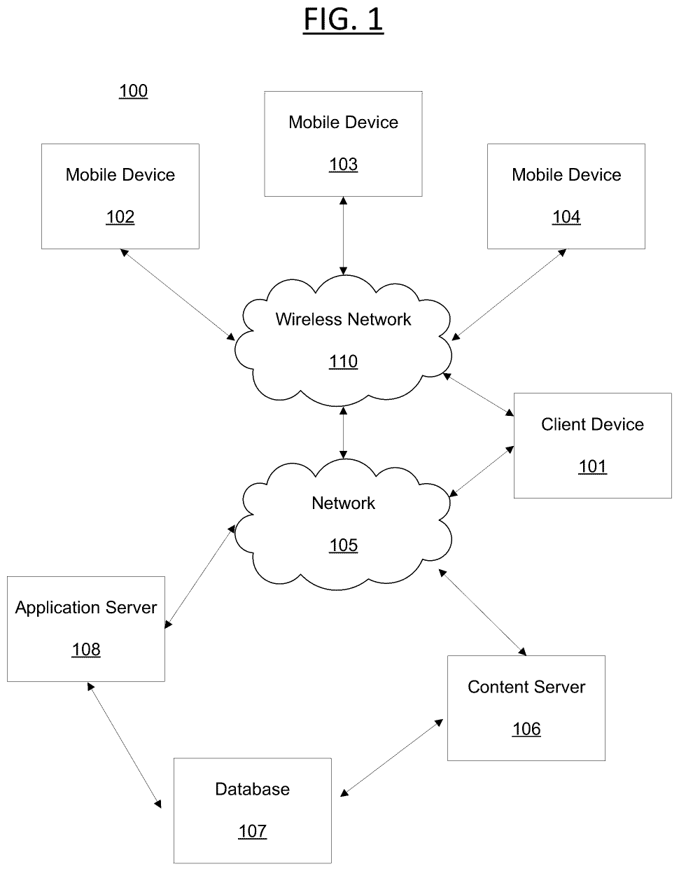

Certain embodiments will now be described in greater detail with reference to the figures. In general, with reference to FIG. 1, a system 100 in accordance with an embodiment of the present disclosure is shown. FIG. 1 shows components of a general environment in which the systems and methods discussed herein may be practiced. Not all the components may be required to practice the disclosure, and variations in the arrangement and type of the components may be made without departing from the spirit or scope of the disclosure. As shown, system 100 of FIG. 1 includes local area networks (“LANs”)/wide area networks (“WANs”)-network 105, wireless network 110, mobile devices (client devices) 102-104 and client device 101. FIG. 1 additionally includes a variety of servers, such as content server 106 and application (or “App”) server 108.

One embodiment of mobile devices 102-104 may include virtually any portable computing device capable of receiving and sending a message over a network, such as network 105, wireless network 110, or the like. Mobile devices 102-104 may also be described generally as client devices that are configured to be portable. Thus, mobile devices 102-104 may include virtually any portable computing device capable of connecting to another computing device and receiving information, as discussed above.

Mobile devices 102-104 also may include at least one client application that is configured to receive content from another computing device. In some embodiments, mobile devices 102-104 may also communicate with non-mobile client devices, such as client device 101. or the like. In one embodiment, such communications may include sending and/or receiving messages, searching for, viewing and/or sharing memes, photographs, digital images, audio clips, video clips, or any of a variety of other forms of communications.

Client devices 101-104 may be capable of sending or receiving signals, such as via a wired or wireless network, or may be capable of processing or storing signals, such as in memory as physical memory states, and may, therefore, operate as a server.

Wireless network 110 is configured to couple mobile devices 102-104 and its components with network 105. Wireless network 110 may include any of a variety of wireless sub-networks that may further overlay stand-alone ad-hoc networks, and the like, to provide an infrastructure-oriented connection for mobile devices 102-104.

Network 105 is configured to couple content server 106, application server 108, or the like, with other computing devices, including, client device 101, and through wireless network 110 to mobile devices 102-104. Network 105 is enabled to employ any form of computer readable media or network for communicating information from one electronic device to another.

The content server 106 may include a device that includes a configuration to provide any type or form of content via a network to another device. Devices that may operate as content server 106 include personal computers, desktop computers, multiprocessor systems, microprocessor-based or programmable consumer electronics, network PCs, servers, and the like. Content server 106 can further provide a variety of services that include, but are not limited to, email services, instant messaging (IM) services, streaming and/or downloading media services, search services, photo services, web services, social networking services, news services, third-party services, audio services, video services, SMS services, MMS services, FTP services, voice over IP (VOIP) services, or the like.

In some embodiments, content server 106 can be, or may be coupled or connected to, a third party server that stores online advertisements for presentation to users. In some embodiments, various monetization techniques or models may be used in connection with sponsored advertising, including advertising associated with user data, as discussed below, where ads can be modified and/or added to content based on the personalization of received content using the locally accessible user profile.

In some embodiments, users are able to access services provided by servers 106 and/or 108. This may include in a non-limiting example, search servers, authentication servers, email servers, social networking services servers, SMS servers, IM servers, MMS servers, exchange servers, photo-sharing services servers, ad servers and travel services servers, via the network 105 using their various devices 101-104.

In some embodiments, applications, such as, but not limited to, news applications, mail applications, instant messaging applications, blog, photo or social networking applications, search applications, and the like, can be hosted by the application server 108, or content server 106 and the like.

Thus, the application server 108 and/or content server 106, for example, can store various types of applications and application related information including application data and other various types of data related to the content and services in an associated database 107, as discussed in more detail below. Embodiments exist where the network 105 is also coupled with/connected to a Trusted Search Server (TSS) which can be utilized to render content in accordance with the embodiments discussed herein. Embodiments exist where the TSS functionality can be embodied within servers 106 and/or 108.

Moreover, although FIG. 1 illustrates servers 106 and 108 as single computing devices, respectively, the disclosure is not so limited. For example, one or more functions of servers 106 and/or 108 may be distributed across one or more distinct computing devices. Moreover, in one embodiment, servers 106 and/or 108 may be integrated into a single computing device, without departing from the scope of the present disclosure.

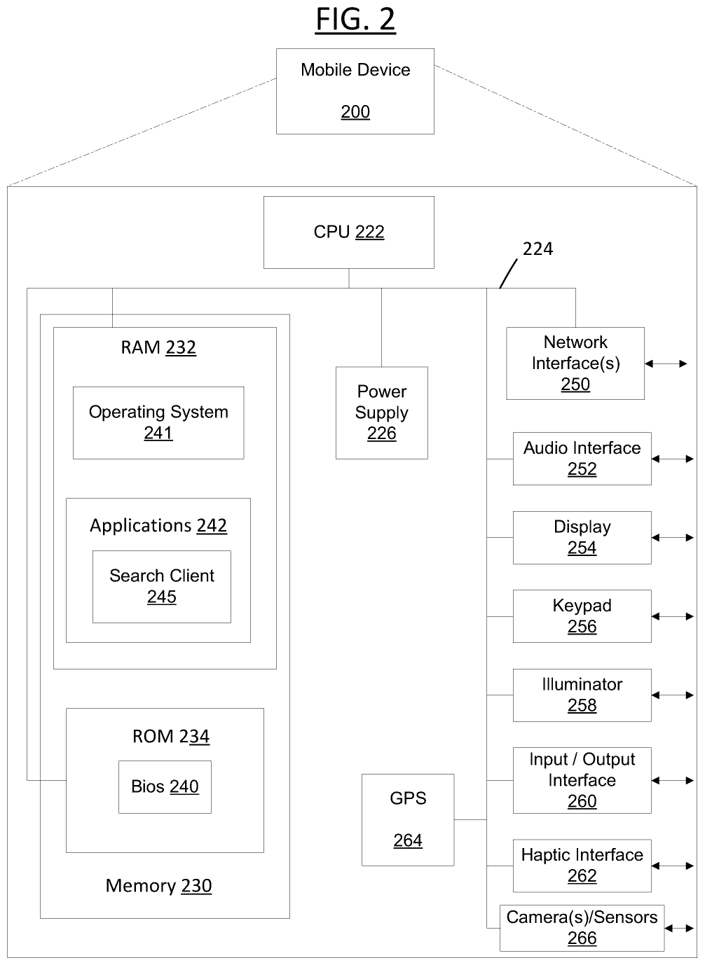

FIG. 2 is a schematic diagram illustrating a client device showing an example embodiment of a client device that may be used within the present disclosure. Client device 200 may include many more or less components than those shown in FIG. 2. However, the components shown are sufficient to disclose an illustrative embodiment for implementing the present disclosure. Client device 200 may represent, for example, client devices 101-104 discussed above in relation to FIG. 1.

As shown in the figure, client device 200 includes a processing unit (CPU) 222 in communication with a mass memory 230 via a bus 224. Client device 200 also includes a power supply 226, one or more network interfaces 250, an audio interface 252, a display 254, a keypad 256, an illuminator 258, an input/output interface 260, a haptic interface 262, an optional global positioning systems (GPS) receiver 264 and a camera(s) or other optical, thermal or electromagnetic sensors 266. Device 200 can include one camera/sensor 266, or a plurality of cameras/sensors 266, as understood by those of skill in the art. Power supply 226 provides power to client device 200.

Client device 200 may optionally communicate with a base station (not shown), or directly with another computing device. Network interface 250 is sometimes known as a transceiver, transceiving device, or network interface card (NIC).

Audio interface 252 can be arranged to produce and receive audio signals such as, for example, the sound of a human voice. Display 254 can, but is not limited to, a include a touch sensitive screen arranged to receive input from an object such as a stylus or a digit from a human hand. Keypad 256 can comprise any input device arranged to receive input from a user. Illuminator 258 may provide a status indication and/or provide light.

Client device 200 also comprises input/output interface 260 for communicating with external devices. Input/output interface 260 can utilize one or more communication technologies, such as USB, infrared, Bluetooth™, or the like. Haptic interface 262 is arranged to provide tactile feedback to a user of the client device.

Optional GPS transceiver 264 can determine the physical coordinates of client device 200 on the surface of the Earth. In some embodiments however, client device 200 may through other components, provide other information that may be employed to determine a physical location of the device, including for example, a MAC address, Internet Protocol (IP) address, or the like.

Mass memory 230 includes a RAM 232, a ROM 234, and other storage means. Mass memory 230 stores a basic input/output system (“BIOS”) 240 for controlling low-level operation of client device 200. The mass memory also stores an operating system 241 for controlling the operation of client device 200

Memory 230 further includes one or more data stores, which can be utilized by client device 200 to store, among other things, applications 242 and/or other information or data. For example, data stores may be employed to store information that describes various capabilities of client device 200. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within client device 200.

Applications 242 may include computer executable instructions which, when executed by client device 200, transmit, receive, and/or otherwise process audio, video, images, and enable telecommunication with a server and/or another user of another client device. Applications 242 may further include search client 245 that is configured to send, to receive, and/or to otherwise process a search query and/or search result.

Having described the components of the general architecture employed within the disclosed systems and methods, the components' general operation with respect to the disclosed systems and methods will now be described below.

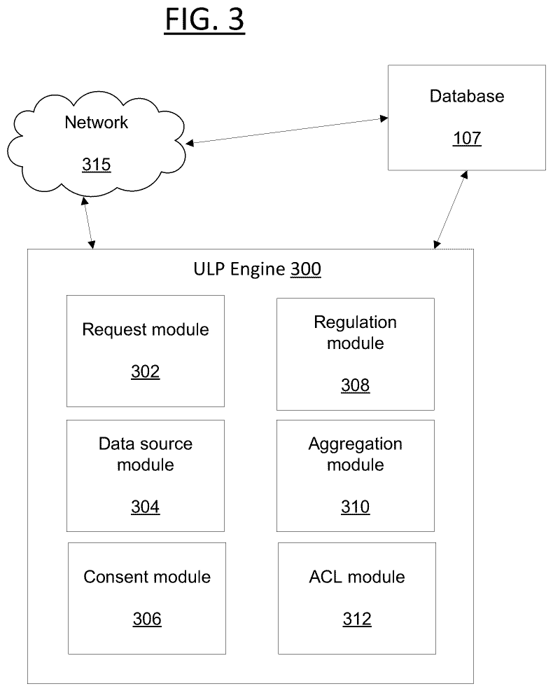

FIG. 3 is a block diagram illustrating the components for performing the systems and methods discussed herein. FIG. 3 includes ULP (user, location, publisher) engine 300, network 315 and database 107. The ULP engine 300 can be a special purpose machine or processor and could be hosted by a network server (e.g., cloud web services server(s)), messaging server, application server, content server, social networking server, web server, search server, content provider, third party server, user's computing device, and the like, or any combination thereof.

According to some embodiments, ULP engine 300 can be embodied as a stand-alone application that executes on a networking server. In some embodiments, the ULP engine 300 can function as an application installed on a user's device, and in some embodiments, such application can be a web-based application accessed by the user device over a network. In some embodiments, the ULP engine 300 can be configured and/or installed as an augmenting script, program or application (e.g., a plug-in or extension) to another application or portal data structure.

The database 107 can be any type of database or memory, and can be associated with a content server on a network (e.g., content server, a search server or application server) or a user's device (e.g., device 101-104 or device 200 from FIGS. 1-2). Database 107 includes a dataset of data and metadata associated with local and/or network information related to users, services, applications, content, content and/or service providers, third party websites and the like.

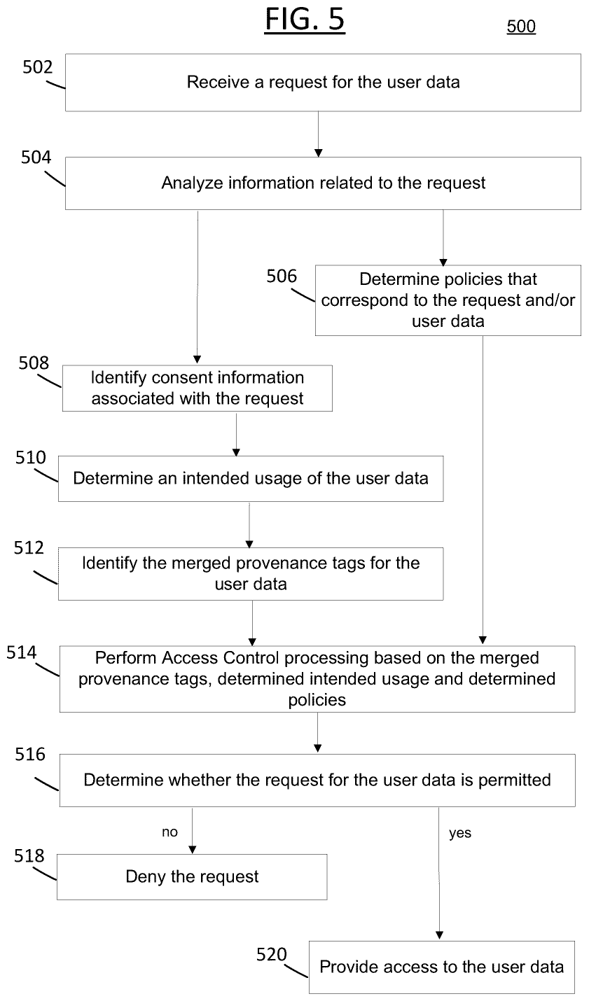

In some embodiments, such information can be stored and indexed in the database 107 independently and/or as a linked or associated dataset. In some embodiments, database 107 can be any type of known or to be known data storage on a network, including, but not limited to, a look-up table (LUT), a node on a network, an edge device, peer on a network, file storage, block storage, object storage, distributed ledger (e.g., blockchain), object orientated database, distributed database, centralized database, and the like. Database 107 can receive storage instructions/requests from, for example, engine 300 (see, e.g., Step 502 of Process 500 of FIG. 5, discussed infra), which may be in any type of known or to be known format, such as, for example, standard query language (SQL).

As discussed herein, it should be understood that the data and metadata in the database 107 can be any type of information and type, whether known or to be known, without departing from the scope of the present disclosure. By way of a non-limiting example, as discussed in more detail below, the data can correspond to, but is not limited to, any type of content (e.g., text, web pages, images, video, and the like, for example), and indicate certain laws, regulations and/or contractual constraints (e.g., policies, such as, for example, GDPR, e-Privacy directives, California's CCPA, Brazil's LGDP, Apple ® App Tracking Transparency (A.T.T.), and the like). Moreover, the data/metadata in database 107 can further include user information, such as, but not limited to, identifier (ID), address, email address, geographic information, demographic information, social media information, behavioral patterns, real-world activity information (e.g., GPS data collected from a device of the user, for example), digital activity information (e.g., search and/or web history, for example), device or browser (e.g., consent) information (e.g., types of devices or browsers, and/or cookie settings on such browsers and/or user devices, for example), and the like, or some combination thereof.

As discussed above, with reference to FIG. 1, the network 315 can be any type of network such as, but not limited to, a wireless network, a local area network (LAN), wide area network (WAN), the Internet, or a combination thereof. The network 315 facilitates connectivity of the ULP engine 300, and the database 107 of stored resources. Indeed, as illustrated in FIG. 3, the ULP engine 300 and database 107 can be directly connected by any known or to be known method of connecting and/or enabling communication between such devices and resources.

The principal processor, server, or combination of devices that comprise hardware programmed in accordance with the special purpose functions herein is referred to for convenience as ULP engine 300, and includes request module 302, data source module 304, consent module 306, regulation module 308, aggregation module 310 and Access Control Logic (ACL) module 312. It should be understood that the engine(s) and modules discussed herein are non-exhaustive, as additional or fewer engines and/or modules (or sub-modules) may be applicable to the embodiments of the systems and methods discussed. The operations, configurations and functionalities of each module, and their role within embodiments of the present disclosure will be discussed below.

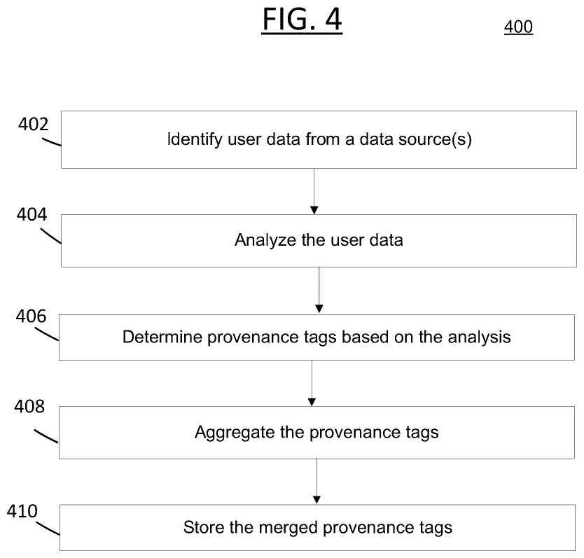

Turning to FIG. 4, Process 400 details non-limiting example embodiments for the permissioned usage of user data. As discussed herein, Process 400 provides computerized mechanisms for generating merged provenance tags for user data, which as provided below in relation to Process 500 of FIG. 5, can be leveraged to determine whether the data is compatible with its declared or determined usage.

By way of background, as discussed above, conventional safeguarding systems must reprocess their “safeguards” for each request. For example, the data/metadata related to a request for a specific user data set must be fully analyzed in a redundant manner to determine whether the usage, consent and laws/regulations are in concert in order to effectuate enabling access to the data. Such static, iterative mechanisms are not only stagnant in the manner in which they can be applied, but can lead to increased resource drain and unnecessary computational expenditure in handling read/write requests for the data. That is, reprocessing and reimplementing safeguard mechanisms each time a user (e.g., party, entity or company, for example) requests read/write access to data is not only an inefficient manner in handling data requests, but also can lead to inaccurate or illegal (e.g., non-compliant) read/write operations that are not compatible with the relevant policies.

As provided herein, the disclosed systems and methods, via the execution and computer-executable instructions provided via engine 300, can enable the handling of an increased volume and a wider variety of processing situations while remaining compliant with the relevant laws, regulations and/or contractual obligations (e.g., policies, used as a general term to reference governing laws, regulations and/or constraints that provide legality to data access and usage (e.g., read/write operations, for example)).

By way of a non-limiting example, a Portuguese user, with a laptop and an iPhone® with several Yahoo® apps executing thereon has their activity split across devices. One or both of the devices travels between Portugal and California, and while in California, the user spends time reading a Brazilian web site.

From this example, there are a wide variety of possibly applicable regulatory schemes. For example, the EU's GDPR and e-Privacy Directive, California's CCPA, Brazil's LGDP, and Apple's App Tracking Transparency (A.T.T.). Each of the above policies restricts the use of some subset of the data collected, and when processing the whole of all the data, complex interactions between the policies must also be considered.

Therefore, since the complete collection of events must be considered, managing access via standard database methods (e.g. partitioning or controlling access to specific rows, columns, or cells) are insufficient, as the number of possible combinations is large and growing.

To address such computational concerns, as discussed herein, the disclosed framework can determine and leverage the combination of the relevant metadata (e.g., related to the request, the user data, usage of the data and/or policies related to the data, for example), and provide data consumers with the answer the question “Can I use this data for my purpose?” (e.g., user path analysis, advertising personalization, segment creation for sale to third parties, and the like, for example).

As discussed herein, the disclosed technology advances beyond the ability of existing systems (e.g., the internal privacy policies and/or commercial systems, such as CollibraIM or Lake Formation tools by Amazon®), which tend to focus on table-, row-, column-, or cell-level access rules. Rather, the disclosed technology provides functionality for taking into account a much wider range of context signals and persisting the relevant metadata through aggregations. As a result, the disclosed functionality provides safeguards for the user data for the maximum allowable use of the data while remaining fully compliant with all required data handling obligations.

According to some embodiments, Steps 402-406 of Process 400 can be performed by data source module 304 of ULP engine 300; and Steps 408-410 can be performed by aggregation module 310.

According to some embodiments, Process 400 begins with Step 402 where engine 300 identifies user data from a data source(s). In some embodiments, the user data can be collected from a set or plurality of data sources; however, for purposes of this discussion, a single data source will be referenced, which one of ordinary skill in the art would recognize as not limiting to the disclosure of the technological scope discussed herein.

According to some embodiments, a data source can be an initial and/or current location where data is digitized (e.g., first “born” or recently modified, for example). A data source can be any type of network location, database, flat file, scraped web data, and/or any other type of static or streaming data service accessible over a network. In some embodiments, data sources can be a type, such as, for example, machine data source, file data sources, and the like. As discussed herein, data sources can house user data that can be requested by a user and transported via diverse network protocols (e.g., File Transfer Protocol (FTP), Hypertext Transport Protocol (HTTP), and the like), and/or via any type of known or to be known application program interface (API) provided by applications, websites and/or other networked services.

In some embodiments, as discussed above, the user data can correspond to, but is not limited to, the information related to real-world and/or network/digital activity of a user, set of users, a company, an entity, and the like, and/or information related to such user(s), and the like, or some combination thereof. In some embodiments, the user data can have included therein timestamps and/or time ranges for which the data items included therein where created and/or last modified/accessed (e.g., a time-to-live (TTL) tag, for example). By way of a non-limiting example, database 107 can be a data source housing user data, as discussed above.

In Step 404, the identified (and retrieved) user data from Step 402 is analyzed by engine 300. In some embodiments, the computational analysis performed by engine 300 can involve parsing the user data and extracting metadata related to the data. In some embodiments, the analysis can be performed via engine 300 executing and/or implementing any type of known or to be known computational analysis technique, algorithm, mechanism or technology, which can include, but is not limited to, a specific trained artificial intelligence/machine learning (AI/ML) model, a particular machine learning model architecture, a particular machine learning model type (e.g., convolutional neural network (CNN), recurrent neural network (RNN), autoencoder, support vector machine (SVM), and the like), or any other suitable definition of a machine learning model or any suitable combination thereof.

In some embodiments, engine 300 may be configured to utilize one or more AI/ML techniques including, but not limited to, computer vision, feature vector analysis, decision trees, boosting, support-vector machines, neural networks, nearest neighbor algorithms, Naive Bayes, bagging, random forests, logistic regression, and the like. In some embodiments, a neural network technique may be one of, without limitation, feedforward neural network, radial basis function network, recurrent neural network, convolutional network (e.g., U-net) or other suitable network.

Accordingly, the metadata determined via engine 300's analysis of the user data can correspond to, but is not limited to, ID of a user(s) associated with the data, demographic information, geographic information, jurisdictions related to the data, ID of the publisher (as well as geographic information related thereto), organizations associated with the data and/or ID, and the like, or some combination thereof. In some embodiments, therefore, the metadata can provide information related to the user, geopolitical, a site(s), and/or any other type of related expiry data.

In Step 406, based on the analysis of the data from Step 404, where the metadata related to the data was identified/determined, engine 300 can determine provenance tags for the user data. In some embodiments, the provenance tags provide the “lineage” information related to the generation and/or current hosting and safeguarding protocols governing the data's current state (e.g., whether it can be accessed and/or by whom, for example). For example, the provenance tags can correspond to specific types of metadata that detail information related to, but not limited to, the origin, read/write rights, changes to and/or current state of the data, and/or temporal/spatial information related thereto, and the like, or some combination thereof. For example, which user ID created the data, when and where it was created, on which platform, which current user ID is the owner of the data (or has read/write rights to the data), and the like.

In some embodiments, the provenance tags can be generated based on the specific types of metadata determined in Step 404; and in some embodiments, the tags can be identified in accordance with the specific types of metadata. According to some embodiments, the provenance tags can include specific provenance tags for each type of metadata. For example, there can be a user provenance tag, a geopolitical provenance tag, a site-based provenance tag and a expiry provenance tag (e.g., TTL, for example), as provided above.

In Step 408, engine 300 can aggregate the provenance tags. In some embodiments, the aggregation performed by engine 300 can result in a structure (e.g., a hierarchical tree, vector and/or other type of organizational data structure) where the most restrictive tags are to be considered first. For example, if the provenance tags indicate that only users in Brazil can access data, and indicate that only users of a specific web-portal can access the data with read-only rights, then the user provenance tags may be provided before the geopolitical provenance tags in the generated structure. In some embodiments, the provenance tags may correspond to mechanisms for the manner employees of an entity (e.g., a company) can handle data in accordance with certain legal requirements and end-user consent data. In some embodiments, the aggregation in Step 408 can result in a new tag being applied to the data (and/or data structure), whereby the new tag can indicate at least a portion of the provenance tags related thereto (e.g., the most restrictive tag, for example).

According to some embodiments, the aggregation performed by engine 300 can be performed via engine 300 executing any type of known or to be known algorithm, technique or technology that can aggregate tags in a weighted manner taking into consideration how the weighting and tagged metadata impacts how data can be accessed, communicated, modified, stored, and the like. For example, such algorithms can include, but are not limited to, in-network Aggregation, Tree-based Aggregation, Cluster-based Aggregation, Multi-path Aggregation, and the like, or some combination thereof. In some embodiments, the aggregations can account for and/or utilize max( )functions, min( )functions, span_max( )functions, and the like, which can control a number of tag enumerations that can be included within the aggregation structure.

Thus, as a result of Step 408, a merged set of provenance tags are generated, which can be stored in datastore (e.g., database 107, for example), as in Step 410.

According to some embodiments, the data modelling performed via Process 400 can be executed based on a detected request/query (e.g., Step 502 of Process 500, discussed below). In some embodiments, the data modelling can be performed upon the detection of an event that may limit or restrict usage of the data (e.g., a sale of the data, creation of the data, and the like). Accordingly, the modelling discussion above respective to Process 400 can be performed for a variety of reasons according to a variety of detected events. In some embodiments, once created, the aggregation/merged data structure can be utilized for multiple requests without having to be reprocessed, as discussed above.

Turning to FIG. 5, Process 500 provides decision-intelligence (DI)-based mechanisms for determining whether user data can be accessed by a requesting user (e.g., a person, customer, entity, portal, service, provider, network, and the like, for example).

According to some embodiments, Steps 502-504 of Process 500 can be performed by request module 302 of ULP engine 300; Step 506 can be performed by regulation module 308; Step 508 can be performed by consent module 306; and Steps 510-520 can be performed by ACL module 312.

According to some embodiments, Process 500 can begin with Step 502 where engine 300 receives a request (or query, as discussed above) for the user data (e.g., the data modelled via the processing of Process 400 of FIG. 4, discussed supra). In some embodiments, as discussed above, the request can correspond to a read/write request for access to network hosted data, a sale of the data, use of the data for purposes of online advertising, and the like, or some combination thereof.

Accordingly, in some embodiments, the request can originate from any type of user, which can include, but is not limited to, a customer, subscriber, organization, company, and/or any other type of known or to be known definable entity that can utilize data for personal and/or business purposes.

In Step 504, engine 300 can analyze the request, which includes analyzing the data related to the request as well as the data included within the request. For example, the information related to the requesting entity can be analyzed, as well as the information identifying the user data within the request can be analyzed. The analysis can also involve determining geographic and temporal information related to the request (e.g., event metadata—for example, a query/event time). Accordingly, in some embodiments, the analysis can be performed in a similar manner as discussed above in relation to the computational analysis performed by engine 300 in Step 404 above.

In Step 506, based on the analysis of Step 504, engine 300 can determine or identify a set of policies (e.g., regulations, laws, constraints or other jurisdictional guidelines for controlling and providing data privacy, as discussed above) that correspond to the request and/or the user data. In some embodiments, the policies can be based on a type of request (e.g., read or write requests), location of data source housing the data, and/or the ID of the requesting user, which can correspond to the identity of the user, type of device of the user being used for the request, the location of the user, and the like.

In some embodiments, Step 506 and Step 508 can be performed in parallel, or in varying order (e.g., Step 506 then Step 508, or vice versa). In some embodiments, Step 506 can be performed during or after completion of Steps 508-512, as illustrated in FIG. 3 and discussed herein. In some embodiments, Step 506 and Step 508 can require separate analysis (via Step 504) that is specific to the type of information being determined in the respective steps.

In Step 508, based on the analysis of Step 504, engine 300 can determine or identify consent information associated with the request. In some embodiments, the consent information can correspond to and/or provide indications as to an intended purpose for using the user data. In other words, the requesting user is notifying and/or requesting permission before collecting and/or utilizing personalized data. Thus, the consent information can correlate to current consent privacy protocols of the requesting user that require certain types of data to be permissioned prior to read/write access.

In some embodiments, the consent information can be included as a tag, label, header and/or other form of metadata or data within the request. In some embodiments, the consent information can be derived from browser, device and/or account settings of the requesting user.

In Step 510, engine 300 can determine an intended usage of the user data. According to some embodiments, the intended usage can be based on the consent information from Step 508. As discussed below, this can be utilized to determine whether a requested operation (e.g., Step 502) is legally capable of being performed (e.g., compliant with policies, consent and/or provenance tags, as discussed herein).

According to some embodiments, the intended usage can be structured as an item, object or data structure that can include information related to specific field types, for example, a type of user (e.g., a first or third party user, for example), type of usage (e.g., advertising, content personalization, for example), and a consent status (e.g., A.T.T. status).

In Step 512, engine 300 can identify the merged provenance tags for the user data. As discussed above in relation to Process 400 of FIG. 4, such tags can be stored in storage, and retrieved accordingly. In some embodiments, Step 512 can involve performing Steps 402-410 of Process 400 for the user data. In some embodiments, performance of the steps of Process 400 can be triggered upon a determination that the merged provenance tags are not existing, not current and/or need to be updated (which can be based on a predetermined period of time, movement in/out of jurisdictions of the user, and/or an expiry tag associated with the user data, for example).

In Step 514, engine 300 can perform Access Control processing (e.g., via ACL logic (e.g., module 312)), which is based on the merged provenance tags (from Step 512/Process 400), the determined intended usage (from Step 510) and the determined policies for the user data (from Step 506). The Access Control processing executes an analysis based on the identified information, and in Step 516 determines whether the operation being requested in Step 502 is compliant with the applicable policies that control how the user data can be accessed/used.

In some embodiments, the processing in Step 514-516 can correspond to Boolean logic, where the processing can be defined as ACL(Provenance Tag data +Consent of current user/Policies ).

In some embodiments, the Access Control logic processing can be performed via a specifically trained AI/ML model, such as, but not limited to, a neural network, or other type of deep belief network, as discussed above at least in relation to Step 404 of Process 400.

In some embodiments, when the merged provenance tags and the intended usage/consent of the user are determined to be non-compliant with the policies of usage, then engine 300 can deny the request, as in Step 518. In some embodiments, engine 300 can provide a “false” or “NULL” response thereby indicating that the request has been denied. In some embodiments, such “false” response may indicate that a policy (or policies) disallows a type of access (e.g., read access, for example).

In some embodiments, when the merged provenance tags and the intended usage/consent of the user are determined to be compliant with the policies of usage, then engine 300 can determine that the user is permitted, as in Step 520. Thus, in Step 520, the requesting user is provided access to the user data in accordance with the operational manner being requested in Step 502. In some embodiments, engine 300 can provide a “true” response thereby indicating that access is approved. Such response can be provided to the data source housing the user data, which can enable the requesting user permission to access the data in line with their provided request. In some embodiments, the “true” response may also provide an indication/notification of permitted access.

As such, based on the above discussion of Processes 400-500, aggregations of tags for user data can be compiled, and repeatedly utilized for each processing request, which can enable a more efficient, accurate compatibility or compliance analysis regarding whether the data is suitable for its intended purpose.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
receiving, by a device, a request for user data from a user;
analyzing, by the device, the request;
determining, by the device, based on the analysis, a set of policies associated with the user data, the set of policies providing jurisdictional guidelines for controlling how the user data is capable of being used;
determining, by the device, based on the analysis, consent information associated with the request, the consent information corresponding to an intended use of the user data;
identifying, by the device, a data structure comprising merged provenance tags associated with the user data, the merged provenance tags indicating a hierarchical indication of metadata associated with the user data;
performing access control processing, by the device, based on the identified data structure comprising merged provenance tags, the consent information and the set of policies;
determining, by the device, based on the access control processing, access rights to the user data for the user responsive to the request; and
outputting, by the device, a response to the request based on the determined access rights.

2. The method of claim 1, further comprising:
determining, via the access control processing, that the merged provenance tags and consent information are compliant with the set of policies, wherein the access rights comprise functionality enabling the user to access the user data in accordance with the intended use.

3. The method of claim 2, wherein the response is a “true” response indicating approval to access the user data, wherein the enabled access is based on the “true” response.

4. The method of claim 1, further comprising:
determining, via the access control processing, that the merged provenance tags and consent information are non-compliant with the set of policies, wherein the access rights comprise functionality denying the request.

5. The method of claim 1, further comprising:
identifying, from at least one data source, the user data;
analyzing the user data, and determining, based on the analysis, the metadata for the user data;
determining, based on the metadata, provenance tags for each type of the metadata.

6. The method of claim 5, further comprising:
aggregating the determined provenance tags into the data structure of merged provenance tags; and
storing, in data storage, the data structure.

7. The method of claim 6, wherein aggregation into the data structure corresponds to an event, the event comprising a time tag that is included in the provenance tags.

8. The method of claim 1, wherein the intended usage indicated by the consent information comprises a set of field types, wherein the field types indicate a type of user, type of usage and a consent status.

9. The method of claim 1, wherein the set of policies comprise at least one of a regulation, law and contractual obligation.

10. The method of claim 1, wherein the set of policies are based on at least one of an identity of the user, device type of the user, location of the user and geopolitics of the user, wherein the set of policies are further based on information about a publisher of the user data.

11. A non-transitory computer-readable storage medium tangibly encoded with computer-executable instructions, that when executed by a device, performs a method comprising:
receiving, by the device, a request for user data from a user;
analyzing, by the device, the request;
determining, by the device, based on the analysis, a set of policies associated with the user data, the set of policies providing jurisdictional guidelines for controlling how the user data is capable of being used;
determining, by the device, based on the analysis, consent information associated with the request, the consent information corresponding to an intended use of the user data;
identifying, by the device, a data structure comprising merged provenance tags associated with the user data, the merged provenance tags indicating a hierarchical indication of metadata associated with the user data;
performing access control processing, by the device, based on the identified data structure comprising merged provenance tags, the consent information and the set of policies;
determining, by the device, based on the access control processing, access rights to the user data for the user responsive to the request; and
outputting, by the device, a response to the request based on the determined access rights.

12. The non-transitory computer-readable storage medium of claim 11, further comprising:
determining, via the access control processing, that the merged provenance tags and consent information are compliant with the set of policies, wherein the access rights comprise functionality enabling the user to access the user data in accordance with the intended use, wherein the response is a “true” response indicating approval to access the user data, wherein the enabled access is based on the “true” response.

13. The non-transitory computer-readable storage medium of claim 11, further comprising:
determining, via the access control processing, that the merged provenance tags and consent information are non-compliant with the set of policies, wherein the access rights comprise functionality denying the request.

14. The non-transitory computer-readable storage medium of claim 11, further comprising:
identifying, from at least one data source, the user data;
analyzing the user data, and determining, based on the analysis, the metadata for the user data;
determining, based on the metadata, provenance tags for each type of the metadata;
aggregating the determined provenance tags into the data structure of merged provenance tags; and
storing, in data storage, the data structure.

15. The non-transitory computer-readable storage medium of claim 11, wherein the intended usage indicated by the consent information comprises a set of field types, wherein the field types indicate a type of user, type of usage and a consent status.

16. A device comprising:
a processor configured to:
receive a request for user data from a user;
analyze the request;
determine, based on the analysis, a set of policies associated with the user data, the set of policies providing jurisdictional guidelines for controlling how the user data is capable of being used;
determine, based on the analysis, consent information associated with the request, the consent information corresponding to an intended use of the user data;
identify a data structure comprising merged provenance tags associated with the user data, the merged provenance tags indicating a hierarchical indication of metadata associated with the user data;
perform access control processing, by the device, based on the identified data structure comprising merged provenance tags, the consent information and the set of policies;
determine, based on the access control processing, access rights to the user data for the user responsive to the request; and
output a response to the request based on the determined access rights.

17. The device of claim 16, wherein the processor is further configured to:
determine, via the access control processing, that the merged provenance tags and consent information are compliant with the set of policies, wherein the access rights comprise functionality enabling the user to access the user data in accordance with the intended use, wherein the response is a “true” response indicating approval to access the user data, wherein the enabled access is based on the “true” response.

18. The device of claim 16, wherein the processor is further configured to:
determine, via the access control processing, that the merged provenance tags and consent information are non-compliant with the set of policies, wherein the access rights comprise functionality denying the request.

19. The device of claim 16, wherein the processor is further configured to:
identify, from at least one data source, the user data;
analyze the user data, and determine, based on the analysis, the metadata for the user data;
determine, based on the metadata, provenance tags for each type of the metadata;
aggregate the determined provenance tags into the data structure of merged provenance tags; and
store, in data storage, the data structure. 20 The device of claim 16, wherein the intended usage indicated by the consent information comprises a set of field types, wherein the field types indicate a type of user, type of usage and a consent status.
